(19) United States
(12) Patent Application Publication
(10) Pub. No.: US 2025/0077212 A1
(43) Pub. Date: Mar. 6, 2025

(54) SYSTEM AND METHOD FOR UPDATING APPLICATION DATA ON GRAPHICAL PROCESSING UNIT

(71) Applicant: Innoplexus AG, Eschborn (DE)

(72) Inventor: Adarsh Jain, Pune (IN)

(73) Assignee: Innoplexus AG, Eschborn (DE)

(21) Appl. No.: 18/240,697

(22) Filed: Aug. 31, 2023

(51) Int. Cl. G06F 8/65; G06F 9/54

(52) U.S. Cl. CPC G06F 8/65; G06F 9/54

(57) ABSTRACT

A system includes a computing hardware system, a network storage, and one or more data sources. A local processor of a data collector node associated with each data source is configured to collect and store incremental application data to the network storage and transmit a file path of the application data to a data API of the computing hardware system. A processor of the computing hardware system is configured to access the received file path and load the application data into a local memory. The processor is configured to generate a compute thread comprising compute queue and data queue and associate the compute thread to the host application. The processor updates the incremental application data from the local memory to the GPU memory through the compute thread and subsequently to local storage. In addition, the processor updates the application data without restarting the host application.

### FIELD OF TECHNOLOGY

The present disclosure relates to computer systems and, more specifically, to a system and a method of updating application data on a graphical processing unit (GPU).

### BACKGROUND

In the domain of graphical processing unit (GPU) based applications with significant in-memory data, a process of updating the data and reloading the complete data into a GPU memory often necessitates a complete restart of the application. This restart is required to facilitate the loading of both existing data and also of newly added data into the GPU memory. However, this approach results in significant downtime for the application. The downtime experienced is directly proportional to the volume of data that needs to be loaded into a main memory and the GPU memory.

Conventionally, certain attempts have been made to resolve such problems by updating the data on storage and subsequently restarting the entire application. However, such an attempt introduces substantial application downtime, adversely affecting system performance and user experience. The necessity of restarting the application not only disrupts ongoing operations but also imposes limitations on real-time or time-sensitive applications. Thus, the current solutions fail to effectively mitigate the challenges associated with updating GPU memory without significant downtime. Consequently, there is a need to address this issue and provide a process that enables the updating of data in the GPU memory without requiring a complete application restart.

Further limitations and disadvantages of conventional and traditional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a system and a method of updating application data on a graphical processing unit (GPU). The present disclosure seeks to provide a solution to the existing problem of updating data in a GPU memory without requiring a complete application restart. An aim of the present disclosure is to provide a solution that overcomes at least partially the problems encountered in the prior art and provide an improved system and an improved method of updating application data on the GPU.

In one aspect, the present disclosure provides a system for updating application data on a graphical processing unit (GPU), the system comprising:
a computing hardware system comprising the graphical processing unit (GPU), a host application, a local memory, a local storage, a data Application Processing Interface (API), and a processor;
a network storage (NS), wherein the network storage is communicatively coupled to the computing hardware system;
one or more data sources, wherein the one or more data sources is communicatively coupled to the network storage via respective data collector nodes, and wherein each of the respective data collector nodes comprises a local processor;
   wherein the processor is configured to:
      receive a file path of an application data at the data API of the computing hardware system, wherein the file path indicates a storage location the application data is stored in the network storage by the one or more data sources via the respective data collector nodes, and wherein the file path is received on a predefined port of the one or more ports of the data API according to a type of application data;
      access the received file path of the application data from the predefined port of the data API and load the application data in the local memory, wherein the processor creates a loader thread to load the application data in the local memory;
      generate a compute thread comprising one or more compute queue and one or more data queue and associate the compute thread to the host application, wherein the compute thread comprises a context of an application of the GPU; and
      update the application data in the GPU of the computing hardware system without restarting the host application; wherein the update is performed by transmitting the application data loaded in the local memory to the GPU memory through the compute thread.

The system is used for updating the application data on the GPU without restarting the host application. In other words, the system in which the application data, which needs to be queried for all the operations of the application, gets incremental updates without application restart and incurred downtime. This eliminates downtime caused by the restart process and allows the application data to continue running smoothly even during data updates. The data updates not only occur in the GPU but also in the local memory and subsequently local storage of the computing hardware system, which appends the data in the local memory and subsequently local storage, from where the data was loaded into the local memory initially when application started. Moreover, the new documents will be stored in a file system as a new chunk with existing chunks so that the new documents could be loaded directly into the GPU memory from the local memory. The data updates are stored only once in a random access memory, once in GPU memory, and once in a permanent storage. This is particularly advantageous when dealing with large datasets that need to be processed in real time, which enables direct data transfer and updates between the one or more data sources and the host application. Overall, the system addresses the problem of downtime caused by application restarts when updating data in GPU memory. Therefore, the system provides a practical and efficient solution for handling large-scale data updates in high-performance computing environments, enhancing system performance and usability.

In another aspect, the present disclosure provides a method for updating application data a graphical processing unit (GPU), the method comprising:
receiving, by a processor of a computing hardware system, a file path of an application data at a predefined port of the one or more ports of a data API of the computing hardware system, wherein the file path indicates a storage location of the application data stored in a network storage by one or more data sources, and wherein the file path is received on a predefined port of the of the one or more ports of the data API according to a type of application data;
accessing, by the processor, the received file path of the application data from the predefined port of the data API and load the application data in the local memory, wherein the processor creates a loader thread to load the application data in the local memory;
generating, by the processor, a compute thread comprising one or more compute queue and one or more data queue and associate the compute thread to the host application, wherein the compute thread comprises a context of an application of the GPU; and
updating, by the processor, the application data in the GPU of the computing hardware system without restarting the host application; wherein the update is performed by transmitting the application data loaded in the local memory to the GPU memory through the compute thread.

The method achieves all the advantages and technical effects of the system of the present disclosure.

It has to be noted that all devices, elements, circuitry, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIGS. 1A and 1B are block diagrams of a system for updating application data on a graphical processing unit (GPU), in accordance with different embodiments of the present disclosure; and

FIG. 2 is a flowchart of a method for updating application data a graphical processing unit (GPU), in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

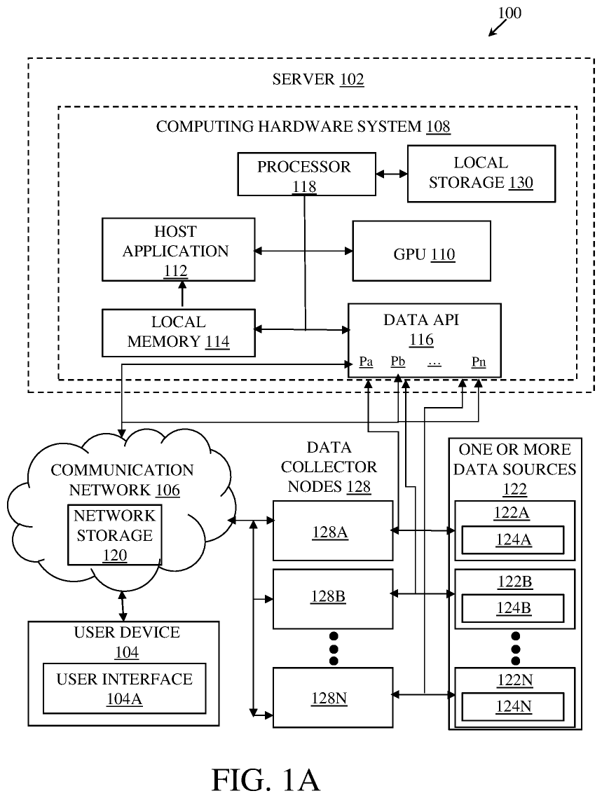

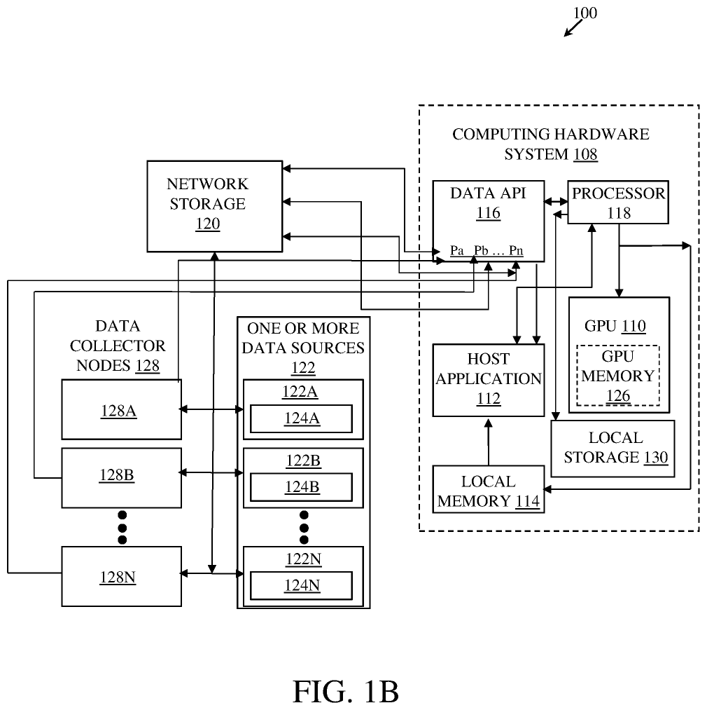

FIGS. 1A and 1B are block diagrams of a system for updating application data on a graphical processing unit (GPU), in accordance with different embodiments of the present disclosure. With reference to FIG. 1A, there is shown a block diagram of a system 100 including the server 102 comprising the computing hardware system 108. With reference to FIG. 1B, there is shown a detailed block diagram of the system 100 with components involved specifically in the updating of application data from the data sources via each of the respective data collector nodes 128. The system 100 includes a computing hardware system 108, a network storage (NS) 120, and one or more data sources 122 in communication with respective nodes 128. There is further shown that the computing hardware system 108 includes a GPU 110, a GPU memory 126, a host application 112, a local memory 114, a local storage 130, a data application processing interface (API) 116, and a processor 118.

In an implementation, the computing hardware system 108 may be implemented in one device, such as a server 102, whereas the one or more data sources 122 may be implemented on another device. In another implementation, the computing hardware system 108, the NS 120, and the one or more data sources 122 may be implemented on a same server, such as the server 102. In an implementation, the network storage 120 may be implemented in one network, such as a communication network 106. In another implementation, the network storage 120 may be implemented in another device, such as another network (not shown). The server 102 may be communicably coupled to a plurality of user devices, such as a user device 104, via the communication network 106. The user device 104 includes a user interface 104A.

The present disclosure provides the system 100 for updating the application data, such as for updating a first application data 124A, a second application data 124B, and up-to Nth application data 124N on the GPU 110 without restarting the host application 112. In other words, the system 100 in which the application data, which needs to be queried for all the operations of the application, gets incremental updates without application restart and incurred downtime. This eliminates downtime caused by the restart process and allows the application to continue running smoothly even during data updates. The data updates not only occur in the GPU 110 but also in the local memory 114 of the computing hardware system 108. Furthermore, the use of a network storage 120 for transferring the application data, such as the first application data 124A from a first data source 122A of the one or more data sources 122 to the GPU 110 allows for data transmission and distribution of data of any amount. This is particularly advantageous when dealing with large datasets that need to be processed in real-time. The system 100 enables the efficient use the GPU 110 by allowing direct data transfer and updates between the one or more data sources 122 and the host application 112. Overall, the system 100 addresses the problem of downtime caused by application restarts when updating data in GPU 110. Therefore, the system 100 provides a practical and efficient solution for handling large-scale data updates in high-performance computing environments, enhancing system performance and usability.

Further, the system 100 enables any amount of data to be incrementally added to the local memory. The data may be a size 1 KB or 1 GB or of larger size. The size of the data from any of the one or more data sources does not in any way affect the updation of application data in the GPU of the system 100. All this is possible without restarting the host application 112.

The server 102 includes suitable logic, circuitry, interfaces, and code that may be configured to communicate with the user device 104 via the communication network 106. In an implementation, the server 102 may be a master server or a master machine that is a part of a data center that controls an array of other cloud servers communicatively coupled to it for load balancing, running customized applications, and efficient data management. Examples of the server 102 may include, but are not limited to a cloud server, an application server, a data server, or an electronic data processing device.

The user device 104 refers to an electronic computing device operated by a user. The user device 104 may be configured to obtain a user input of one or more words in a search engine rendered over the user interface 104a and communicate the user input to the server 102. Examples of the user device 104 may include but are not limited to, a mobile device, a smartphone, a desktop computer, a laptop computer, a Chromebook, a tablet computer, a robotic device, or other user devices.

The communication network 106 includes a medium (e.g., a communication channel) through which the user device 104 communicates with the server 102. The communication network 106 may be a wired or wireless communication network. Examples of the communication network 106 may include, but are not limited to, a Local Area Network (LAN), a wireless personal area network (WPAN), a Wireless Local Area Network (WLAN), a wireless wide area network (WWAN), a cloud network, a Long Term Evolution (LTE) network, a plain old telephone service (POTS), a Metropolitan Area Network (MAN), and/or the Internet.

The GPU 110 corresponds to a specialized electronic circuit designed to accelerate the processing of visual data and complex mathematical computations, primarily used in rendering images and videos on computer screens. Originally developed for rendering graphics in video games and multimedia applications, modern GPUs have evolved into powerful parallel processors capable of performing a wide range of general-purpose computing tasks, beyond graphics rendering. In an example, the GPU 110 may be used for a high-performance data center GPU designed for Artificial Intelligence (AI) and scientific computing workloads, real-time ray tracing capabilities, a GPU used in applications like 3D modeling, CAD, animation, scientific simulations, and the like. The GPU 110 is communicatively coupled with each of the host application 112, and the processor 118 via compute thread. It is well known that, GPUs are peripheral, controlled entirely by CPU/CPU based threads/processes. During any compute task like query processing, CPU prepares and send the data to GPU, instructs what needs to be computed and then collects the results of the computation.

The processor 118 may include certain codes and instructions to be executed to perform various operations for updating the application data in the GPU 110. Examples of the processor 118 may include, but are not limited to, a central processing unit (CPU), a microprocessor, and a microcontroller.

The host application 112 provides a platform for other programs or plugins to run within its environment, enabling extensibility, modularity, and enhanced functionality through integration. The host application 112 may also be referred to as a host program or host software, which refers to a computer program or software application that serves as a main or controlling program in which other programs or modules are executed or integrated. The host application 112 provides an environment or platform for other programs to run within, interact with, or extend its functionalities. The host application 112 manages the execution of such programs or plugins and facilitates communication between them and the underlying operating system or hardware.

The local memory 114 refers to a primary storage of computing hardware system 108 of the server 102. The local memory 114 includes suitable logic, circuitry, and interfaces that may be configured to store the user input received from the user devices, such as the user device 104, and the instructions executable by the processor 118. In an implementation, the local memory 114 corresponds to a Random-Access Memory (RAM). However, other examples of the local memory 114 may include but are not limited to, Electrically Erasable Programmable Read-Only Memory (EEPROM), Read Only Memory (ROM), and/or CPU cache memory. The local storage 130 refers to internal storage of the computing hardware system of the server 102. The local storage 130 may be configured to store the data received from local memory, files, software and data received from other storage locations like network storage, cloud storage, external hard drives etc, in a persistent manner. In an implementation, the local storage 130 may include but not limited to HDD's, SDD's.

The data API 116 corresponds to a set of rules, protocols, and tools that allow software applications to interact and exchange data with a database, a web service, or other data sources, such as the one or more data sources 122. The data API 116 serves as an intermediary between the computing hardware system 108 and the one or more data sources 122, such as to enable seamless communication and data manipulation between the computing hardware system 108 and the one or more data sources 122. The data API 116 is designed to provide a standardized and structured way for applications to access, retrieve, and modify data, abstracting the underlying complexity of the data storage and retrieval processes. The data API comprises one or more software ports Pa, Pb . . . Pn. The ports are designed to receive the data file path of the application data stored in the network storage 120, from the respective data collector nodes 128A-128N

The one or more data sources 122 are communicatively coupled to the computing hardware system 108, such as the one or more data sources 122 includes N number of data sources, such as the first data source 122A, a second data source 122B, and Nth data source 122N. The one or more data sources 122 refers to an origin or locations where the application data is generated, collected, or stored. The one or more data sources 122 can be diverse and can include websites, databases, files, sensors, applications, APIs, web services, cloud platforms, Internet of Things (IoT) devices, social media platforms, and the like. The one or more data sources 122 are crucial for obtaining the information necessary for analysis, processing, and decision-making in various domains, such as business, research, and technology. In an implementation, the one or more data sources are located in different geographical locations. In an implementation, the one or more data sources provide different types of application data, for e.g. application data 124A is of a first type of data and application data and 124B is of a second type of data. In other words, each data source is located or distributed across different geographical locations and provides different type of data for various reasons, including redundancy, performance optimization, data privacy, and regulatory compliance. For example, the first data source 122A is located in a first country and the second data source 122B is located in another country. The placement of each data source in different geographical locations is a strategic decision made based on factors like data access requirements, performance needs, cost considerations, data privacy concerns, and legal requirements. Properly managing distributed data sources is crucial for maintaining data integrity, security, and accessibility across different regions. In an example, at least one data source corresponds to a website from where the updates are to be taken. Furthermore, then there is also respective nodes 128A . . . 128N which collects the application data from the respective data sources, processes the application data, and writes into a file on the network storage 120 and send the file path of the new/incremental data to the data API of the host application 120 via predefined ports for updating/incrementing the respective type of data application.

In operation, each data source from the one or more data sources 122 is configured to generate the application data in the form of plurality of chunks, such that each chunk of the application data includes a plurality of documents. Optionally, the application data is generated in incremental form, such as generated on hourly or daily or weekly or monthly or quarterly or half yearly basis, which depends on a source. In an example, each chunk from the plurality of chunks of the application data contains a specified number of documents (or data entities), such as one million documents in one chunk. Optionally, each document from the plurality of documents represents a unit of data, such as a record, file, or message. In an example, the plurality of chunks can be replicated and distributed across different locations.

In accordance with an embodiment, each data source from the one or more data sources 122 is can be configured to generate a different type of application data. For example, the first data source 122A is configured to generate a first type of application data 124A based on the geographical location of the first data source 122A. Similarly, the second data source 122B is configured to generate a second type of application data 124B based on the geographical location of the second data source 122B. As a result, the different types of application data can be generated with reduced network latency, such as if one data source becomes unavailable due to a localized issue, then the application data from other locations can still be accessed and utilized.

Each data source from the one or more data sources 122 is further configured to store the application data in the network storage 120 via the respective data collector nodes 128. Similarly, each data source is configured to store the corresponding application data (i.e., incremental application data) to the network storage 120. Thereafter, each data source from the one or more data sources 122 is configured to transmit a file path of the application data via respective data collector nodes 128, to the one or more software ports Pa, Pb . . . Pn of the data API 116 of the computing hardware system 108. In an example, the file path of the application data refers to a specific location or address within the network storage 120 where the application data is stored. The absolute file path (e.g., a folder name stored on a particular drive or server of the network storage 120) provides a unique identifier for the location of the application data on the network storage 120.

In accordance with an embodiment, the network storage 120, the one or more data sources 122 via the respective data collector nodes 128, and the host application 112 are communicatively coupled to each other via a cloud service. In such embodiment, the system 100 further includes a socket-based API to communicate between the one or more data sources 122 and the host application 112. As a result, the socket-based API facilitates direct and improved communication between the one or more data sources 122 and the host application 112, enhancing data transfer speed and reducing latency. Moreover, the communication service/cloud service enables seamless and efficient communication between the network storage 120, the one or more data sources 122, and the host application 112.

In operation, the processor 118 of the computing hardware system 108 is configured to access the file path received in the respective ports of the one or more ports of the data API and load the incremental application data from the network storage to the local memory of the computing hardware system. The processor creates a loader thread to load the application data from the network storage to the local memory. Subsequently, the processor 118 is configured to generate a compute thread comprising a compute queue and a data queue and associate the compute thread to the host application 112, such as the compute thread includes a context of an application of the GPU 110. In an example, the compute queue comprises plurality of compute instructions generated by the host application. The host application can generate compute instructions based on an input received from a user using the user device 104. In an example, the processor 118, is configured to prioritize the execution of compute instructions in the compute queue over the data queue. In an example, the data queue comprises plurality of loader threads to load the application data. Each loader thread comprises a different data file path received on the different ports of the data API. It is to be noted that, each of the respective nodes 128 stores the incremental application data at a different location in the network storage thereby generating different data file paths. The respective nodes then transmit the data file path to the respective ports of the data API. Based on the number of data file paths received by the data API in the respective ports, one or more loader threads can be instantiated in the data queue. In an example, the file path of the first application data 124A is different from the file path of the second application data 124B. In an example, the compute thread is allowed to initiate compute or memory transfer instructions on the GPU 110. Subsequently, the processor 118 is configured to update the incremental application data from the local memory 114 to the GPU memory 126 without restarting the host application. This is achieved by transmitting the incremental application data from the local memory to the GPU memory through the compute thread.

In accordance with an embodiment, the processor 118 is further configured to generate N-number of data classes with one or more formats for the plurality of chunks of the application data. Optionally, a definition of the N-number of data classes could be updated in N types. In an example, one or more data classes from the N-number of data classes may be data classes that do not require an update. In such embodiment, the processor 118 is further configured to persist the plurality of chunks of the N-number of data classes in the local storage 130. Optionally, one or more formats for the plurality of chunks persist in the local storage 130 as a list. In such embodiments, the processor 118 is further configured to open N-number of ports in the host application 112 for each format from the one more format for the plurality of chunks. In other words, the processor 118 is configured to open the N-number of ports for each type of application data.

It is to be noted that, the maintenance of compute queue comprising compute instructions and data queue comprising loader threads separately by the compute thread and the interweaving of execution of compute queue and data queue for updating the application data in the GPU enables updating the application data without requiring a restart of the application which is made possible by the system and method of the current invention. In prior solutions, once the data is updated/added a restart was required for accessing the updated data in subsequent compute instructions. In this application the term update is used in the context of adding/appending the application data in increments. In other words, the existing data in the network storage or the local storage remains the same and only newly crawled/collected or additional data as provided by the one or more data sources is added/appended to the storage.

In accordance with an embodiment, the local memory 114 is a random-access memory (RAM) including a memory buffer, and the GPU 110 includes a GPU memory 126, such as the compute thread instructs the processor 118 to transmit the application data from the memory buffer of the RAM to the GPU memory 126. Optionally, the compute thread is used by the processor 118 to execute, a compute instructions/query CQ (e.g., a usual workflow), and a data query (incremental data update), such as a data query (DQ) to enable updating of the incremental application data in the GPU memory 126. In an implementation, the compute thread is used by the processor 118 to check if there are any query CQ in compute queue. If there are any CQ's then the processor proceed to execute the CQ's. In the event that all the CQ's have been executed or the CQ is empty, the processor proceeds to execute the DQ. The priority of execution of the compute query is higher than the priority of execution of the data query. Optionally, when the execution of the DQ is decided, then the compute thread instructs the processor 118 to transfer the application data from the memory buffer of a local memory (i.e., RAM) to the GPU memory 126, as shown in FIG. 1B. Furthermore, the execution of the next element of the CQ will include the application data comprising the incremental data update.

In accordance with an embodiment, each data source from the one or more data sources 122A-122N is configured to provide application data 124A-124N of one or more data classes. A web-based program such as a crawler residing in a webpage or any application program, collects/crawls for updated data from the one or more data sources, processes the data and further appends the network storage with latest data from the data sources. In an alternate embodiment, the data sources 122A-122N, can be an application program with associated application data. In this embodiment, each data source allows for distributed and parallel data updates. Each data source can focus on specific data classes, leading to efficient and simultaneous updates, reducing data processing bottlenecks, and improving overall system performance.

The system 100 is used for updating the application data, such as for updating a first application data 124A, a second application data 124B, and up-to Nth application data 124N on the GPU 110 without restarting the host application 112. In other words, the system 100 in which the application data, which needs to be queried for all the operations of application, gets incremental updates without restarting the host application 112 and without causing downtime. This approach enhances performance of the system 100 and reduces the need for the host application 112 restart, leading to improved efficiency and a seamless user experience. This eliminates downtime caused by the restart process and allows the application data to continue running smoothly even during data updates. The data updates not only occur in the GPU 110 but also in the local storage 130 (HDD/SDD) of the computing hardware system 108. Furthermore, the use of the network storage 120 for transferring the application data, such as the first application data 124A from a first data source 122A of the one or more data sources 122 to the GPU 110 allows for data transmission and distribution of any amount or size of application data. This is particularly advantageous when dealing with large datasets that need to be processed in real-time. The system 100 enables the efficient use of the GPU memory 126 by allowing direct data transfer and updates between the one or more data sources 122 and the host application 112. Therefore, the system 100 addresses the problem of downtime caused by application restarts when updating data in GPU 110. Furthermore, the system 100 provides a practical and efficient solution for handling large-scale data updates in high-performance computing environments, enhancing system performance and usability.

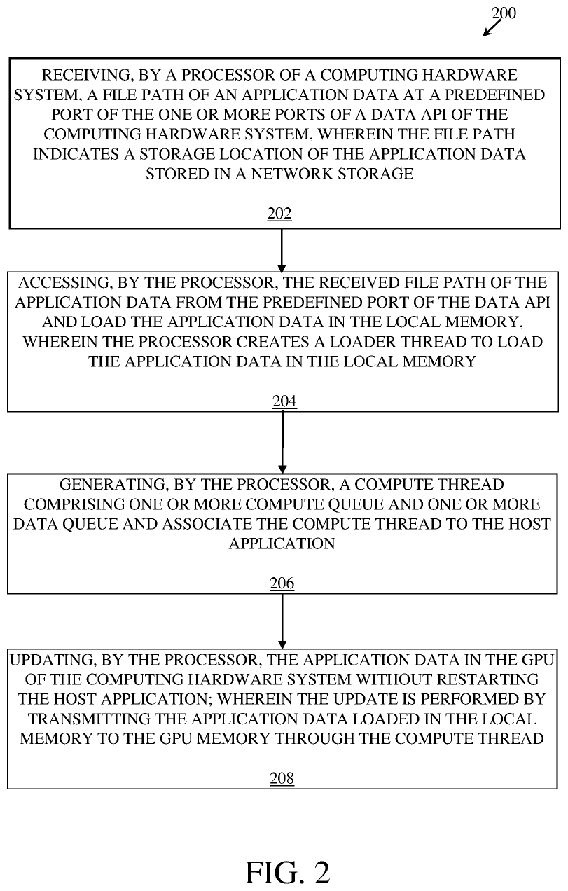

FIG. 2 is a flowchart of a method for updating application data on a graphical processing unit (GPU, in accordance with an embodiment of the present disclosure. FIG. 2 is explained in conjunction with elements from FIGS. 1A and 1B. With reference FIG. 2, there is shown a flowchart of a method 200 for updating the application data on the GPU 110 without restarting the host application 112. The method 200 is executed at the server 102 (of FIG. 1). The method 200 may include steps 202 to 208.

At step 202, the method 200 includes receiving, by a processor of the computing hardware system, a file path of an application data at a predefined port of the one or more ports of the data API. The file path indicates a storage location of the application data stored in a network storage by one or more data sources. The file path is received on a predefined port of the data API according to a type of application data provided by the one or more data sources.

At step 204, the method 200 includes accessing by the processor the received file path of the application data from the predefined port of the data API and load the application data in the local memory. The processor creates a loader thread that enables to load the application data in the local memory.

In accordance with an embodiment, the method 200 further includes utilizing a network communication service/cloud service to establish a connection among the network storage 120, the one or more data sources, and the host application. In such embodiment, the method 200 further includes utilizing a socket-based API to communicate between the one or more data sources 122 and the host application 112. As a result, the socket-based API facilitates direct and improved communication between the one or more data sources 122 and the host application 112, enhancing data transfer speed and reducing latency. Moreover, the network communication service/cloud service enables seamless and efficient communication between the network storage 120, the one or more data sources 122, and the host application 112.

At step 206, the method 200 includes generating by the processor a compute thread. The compute thread comprises a compute queue and a data queue. The processor then associates the compute thread with the host application. The compute thread comprises a context of an application of the GPU. The compute queue comprises compute instructions/query that when executed by the processor performs actions related to requests generated by the user of a user device or other normal workflow related actions that are generally performed by the processor.

At step 208, the method 200 includes updating by the processor the application data in the GPU of the computing hardware system without restarting the host application. This is done by transmitting the application data from the local memory to the GPU memory through the compute thread. Any subsequent request for application data either by a request from a user using a user device or normal processing of compute instructions/query by the processor will be performed on the updated data in the local memory/storage and/or the GPU memory.

In accordance with an embodiment, the method 200 further includes generating, by the processor 118, N-number of data classes with one or more formats for the plurality of chunks of the application data. Optionally, a definition of the N-number of data classes could be updated in N types. In an example, one or more data classes from the N-number of data classes may be data classes that does not require an update. In such embodiment, the method 200 further includes persisting the plurality of chunks of the N-number of data classes in the local storage 130. Optionally, one or more formats for the plurality of chunks persist in the local storage 130 as a list. In such embodiments, the method 200 further includes opening N-number of ports in the data API 116 for each format from the one more format for the plurality of chunks. In other words, the method 200 includes opening the N-number of ports for each type of application data.

In an implementation, each of the compute query and the data query is maintained in the compute thread, which holds the context of the GPU 110. In an implementation, the compute thread is used by the processor 118 to execute each query, such as to execute the first compute query in the compute thread as well as to execute the second compute query in the compute thread. Furthermore, the compute thread is allowed to initiate compute or memory transfer instructions on the GPU 110, such as to store the application data in the local memory 114. In another implementation, the loader thread is used by the processor 118 to read/extract the application data from the network storage 120 to the local memory 114. Optionally, the loader thread is used by the processor 118 to load and subsequently update the incremental application data in the local memory 114 without restarting the host application.

In accordance with an embodiment, the method 200 further includes updating, by each data source from the one or more data sources, the application data of one or more data classes. In this embodiment, each data source allows for distributed and parallel data updates. Each data source can focus on specific data classes, leading to efficient and simultaneous updates, reducing data processing bottlenecks, and improving overall system performance.

The method 200 is used for updating the application data on the GPU 110 without restarting the host application 112. This approach enhances performance and reduces the need for the host application 112 to restart, leading to improved efficiency and a seamless user experience. This eliminates downtime caused by the restart process and allows the application data to continue running smoothly even during data updates. The data updates not only occur in the GPU memory 126 of the GPU 110 but also in the local memory 114 and subsequently local storage 130 of the computing hardware system 108. This is particularly advantageous when dealing with large datasets that need to be processed in real-time. The method 200 enables the efficient use of the GPU 110 by allowing direct data transfer and updates between the one or more data sources 122 and the host application 112. Overall, the method 200 addresses the problem of downtime caused by application restarts when updating data in GPU 110. Therefore, the method 200 enables a practical and efficient solution for handling large-scale data updates in high-performance computing environments, enhancing system performance and usability.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A system for updating application data on a graphical processing unit (GPU), the system comprising:
a computing hardware system comprising the graphical processing unit (GPU), a host application, a local memory, a local storage, a data Application Processing Interface (API), and a processor;
a network storage (NS), wherein the network storage is communicatively coupled to the computing hardware system;
one or more data sources, wherein the one or more data sources is communicatively coupled to the network storage via respective data collector nodes, and wherein each of the respective data collector nodes comprises a local processor;
wherein the processor is configured to:
receive a file path of an application data at the data API of the computing hardware system, wherein the file path indicates a storage location the application data is stored in the network storage by the one or more data sources via the respective data collector nodes, and wherein the file path is received on a predefined port of the one or more ports of the data API according to a type of application data;
access the received file path of the application data from the predefined port of the data API and load the application data in the local memory, wherein the processor creates a loader thread to load the application data in the local memory;
generate a compute thread comprising one or more compute queue and one or more data queue and associate the compute thread to the host application, wherein the compute thread comprises a context of an application of the GPU; and
update the application data in the GPU of the computing hardware system without restarting the host application; wherein the update is performed by transmitting the application data loaded in the local memory to the GPU memory through the compute thread.

2. The system according to claim 1, wherein the one or more data sources are located in either same or different geographical locations.

3. The system according to claim 2, wherein each data source from the one or more data sources is configured to generate a different type of application data.

4. The system according to claim 1, wherein the application data from the one or more data sources is generated in the form of plurality of chunks, wherein each of the plurality of chunk of the application data comprises plurality of documents.

5. The system according to claim 4, wherein the processor is further configured to generate N-number of data classes with one or more formats for the plurality of chunks of the application data.

6. The system according to claim 1, wherein the data file path is received on a predefined port of the data API via a local processor of a data collector node associated with each of the one or more data sources.

7. The system according to claim 5, wherein the processor is further configured to open N-number of ports in the data API for each format from the one or more formats of the plurality of chunks of the application data.

8. The system according to claim 1, wherein the local memory is a random access memory (RAM) comprising a memory buffer, and the GPU comprises a GPU memory, wherein the compute thread instructs the processor to transmit the application data from the memory buffer of the RAM to the GPU memory.

9. The system according to claim 1, wherein each data source from the one or more data sources is configured to increment the application data of one or more data classes.

10. The system according to claim 1, wherein the network storage, the one or more data sources, and the host application are communicatively coupled to each other via a cloud service.

11. The system according to claim 1, further comprising a socket-based API to communicate between the one or more data sources and the host application.

12. A method for updating application data a graphical processing unit (GPU), the method comprising:
receiving, by a processor of a computing hardware system, a file path of an application data at a predefined port of the one or more ports of a data API of the computing hardware system, wherein the file path indicates a storage location of the application data stored in a network storage by one or more data sources, and wherein the file path is received on the predefined port of the one or more ports of the data API according to a type of application data;
accessing, by the processor, the received file path of the application data from the predefined port of the data API and load the application data in the local memory, wherein the processor creates a loader thread to load the application data in the local memory;
generating, by the processor, a compute thread comprising one or more compute queue and one or more data queue and associate the compute thread to the host application, wherein the compute thread comprises a context of an application of the GPU; and
updating, by the processor, the application data in the GPU of the computing hardware system without restarting the host application; wherein the update is performed by transmitting the application data loaded in the local memory to the GPU memory through the compute thread.

13. The method according to claim 12, further comprising generating the application data from the one or more data sources in the form of plurality of chunks, wherein each of the plurality of chunk of the application data comprises plurality of documents.

14. The method according to claim 13, further comprising generating, by the processor, N-number of data classes with one or more formats for the plurality of chunks of the application data.

15. The method according to claim 12, further comprising receiving the data file path on a predefined port of the data API via a local processor of a data collector node associated with each of the one or more data sources.

16. The method according to claim 14, further comprising opening N-number of ports in the data API for each format from the one or more formats.

17. The method according to claim 14, further comprising incrementing, by each data source from the one or more data sources via a local processor of a data collector node associated with each of the one or more data sources, the application data of one or more data classes.

18. The method according to claim 12, further comprising utilizing a cloud service to establish a connection among the network storage, the one or more data sources, and the host application.

19. The method according to claim 12, further comprising updating the application data in the GPU memory from the local memory and subsequently to local storage based on the received data file path pertaining to changes in the application data in the network storage.
